(19) United States
(12) Patent Application Publication
(10) Pub. No.: US 2026/0279615 A1
(43) Pub. Date: Sep. 17, 2026

(54) ATOM TRAP DEVICES INCLUDING STRUCTURED ELECTRODE LAYERS

(71) Applicant: Infineon Technologies Austria AG, Villach (AT)

(72) Inventors: Fabian Anmasser, Spittal an der Drau (AT); Nina Agnieszka Megier, Villach (AT); Michael Dieter Josef Pfeifer, Klagenfurt am Worthersee (AT); Jakob Wahl, Villach (AT)

(21) Appl. No.: 19/546,941

(22) Filed: Feb. 23, 2026

(30) Foreign Application Priority Data
Mar. 14, 2025 (DE) 102025109815.8

(51) Int. Cl. G21K 1/30

(52) U.S. Cl. CPC G21K 1/30

(57) ABSTRACT

A device for controlling trapped atoms includes a structured electrode layer having a plurality of electrodes of an atom trap configured to trap atoms in a zone above the structured electrode layer. The electrodes includes a first RF electrode and a second RF electrode extending in a first direction. The first and second RF electrodes are arranged on different sides of an axis extending in the first direction. A plurality of DC electrodes is arranged between the first RF electrode and the second RF electrode. The plurality of DC electrodes includes a first DC electrode having a first portion and a second portion. The first portion and the second portion are arranged symmetrically to each other with respect to the axis. The axis extends between the first portion and the second portion. A second DC electrode is arranged symmetrically to the axis. The axis extends through the second DC electrode.

### TECHNICAL FIELD

The present disclosure relates to devices for controlling trapped atoms. More particularly, the present disclosure relates to structured electrode layers included in devices for controlling trapped atoms.

### BACKGROUND

An operation of atom trap devices may require a shuttling of atoms between different locations in the respective device. For example, ion traps may rely on ion shuttling as a crucial building block for performing quantum computing. In some examples, a structured electrode layer and an associated electrical wiring may be required for shuttling atoms. A use of conventional structured electrode layers may induce additional heating of motional modes and result in decoherence. It may be desirable to provide atom trap devices avoiding such undesired effects.

### SUMMARY

An aspect of the present disclosure relates to a device for controlling trapped atoms. The device comprises a structured electrode layer, wherein the structured electrode layer comprises a plurality of electrodes of an atom trap configured to trap atoms in a zone above the structured electrode layer. The plurality of electrodes comprises a first RF electrode and a second RF electrode extending in a first direction, wherein the first RF electrode and the second RF electrode are arranged on different sides of an axis extending in the first direction, and a plurality of DC electrodes arranged between the first RF electrode and the second RF electrode. The plurality of DC electrodes comprises a first DC electrode comprising a first portion and a second portion, wherein the first portion and the second portion are arranged symmetrically to each other with respect to the axis, wherein the axis extends between the first portion and the second portion, and a second DC electrode arranged symmetrically to the axis, wherein the axis extends through the second DC electrode.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates a top view of a device for controlling trapped atoms.

FIGS. 2A to 2D schematically illustrate a top view (FIG. 2A) and three cross-sectional side views (FIGS. 2B-2D) of a device for controlling trapped atoms in accordance with the disclosure.

FIGS. 3A to 3D schematically illustrate a top view (FIG. 3A) and three cross-sectional side views (FIGS. 3B-3D) of a device for controlling trapped atoms in accordance with the disclosure.

FIG. 4 shows a diagram illustrating shuttling voltages for shuttling an atom in a device for controlling trapped atoms in accordance with the disclosure.

FIG. 5 shows a diagram illustrating secular frequencies of different directions when shuttling an atom in a device for controlling trapped atoms in accordance with the disclosure.

### DETAILED DESCRIPTION

The following description relates to devices for controlling trapped atoms (also referred to as atom trap devices). In particular, the atom trap devices described herein may correspond to ion trap devices, which may be configured to trap ions (charged atoms or molecules) and control the trapped ions. Atom trap devices may be implemented as one or multiple atom trap chips in form of small, micro-fabricated devices configured to trap and manipulate individual atoms in a controlled manner. It is to be noted that the following description is not restricted to atoms, but may also be applied to ions, molecules or other quantum particles/systems (e.g. electrons).

In some examples, atom trap devices as described herein may be used for quantum computing, but are not restricted thereto. Trapped atoms (more particularly, trapped ions) are one of the most promising candidates for being used as qubits in quantum computers, since they can be trapped with rather long lifetimes by means of electromagnetic fields and enable conducting quantum gates with very high fidelities. In this context, each atom may represent a physical qubit. In some examples, the atom trap devices described herein may also be referred to as trapped-ion quantum computer or ion trap quantum processor. However, it is to be noted that atom trap devices in accordance with the disclosure are not restricted to the application of quantum computing. The atom trap devices presented herein may also be used for other applications, such as atomic clocks.

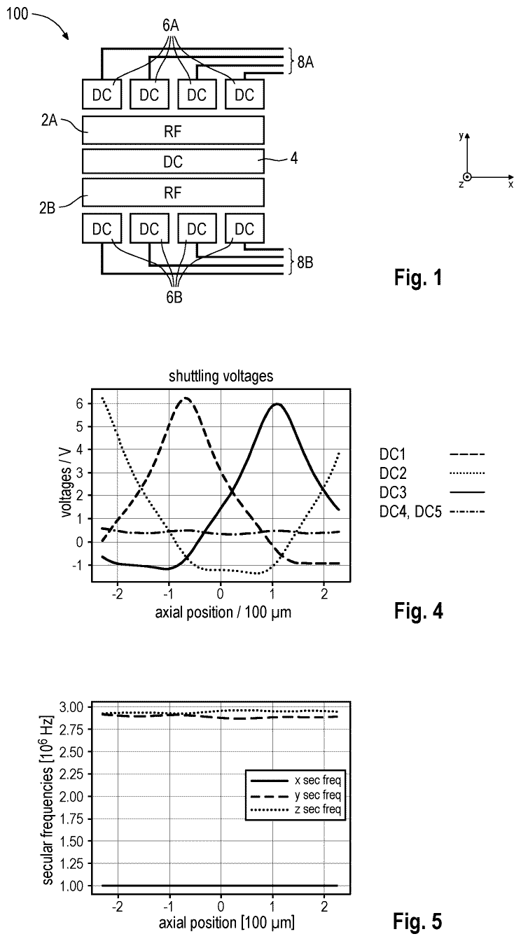

Referring now to FIG. 1, a top view of an atom trap device 100 is shown. More particularly, FIG. 1 illustrates a top view of a structured electrode layer of the atom trap device 100 including a plurality of electrodes formed therein. It is noted that FIG. 1 may only show a portion or a detail of the atom trap device 100, while further device components may be omitted for the sake of simplicity. In the following, an exemplary operation of an atom trap device is described.

In the illustrated example, the structured electrode layer may include a first RF electrode 2A and a second RF electrode 2B extending in the x-direction as well as a center DC electrode 4 arranged between the RF electrodes 2A, 2B and extending parallel to them. In addition, the structured electrode layer may include a first plurality of first DC electrodes 6A arranged adjacent to the first RF electrode 2A and a second plurality of second DC electrodes 6B arranged adjacent to the second RF electrode 2B. In the illustrated example, the structured electrode layer may correspond to a five-wire geometry. It is however to be understood that described aspects are not restricted to five-wire geometries, but may also hold true for other types of atom traps and/or electrode geometries.

In particular, the structured electrode layer and the electrodes formed therein may be arranged in a same single plane. In the illustrated example, the electrodes may extend in a same single x-y-plane at a same z-coordinate. In particular, the atom trap device 100 may correspond to a surface atom trap (or surface-electrode atom trap) in which all electrodes (i.e. the RF electrodes 2A, 2B and the DC electrodes 4, 6A, 6B) may be arranged in a same single plane. However, it is to be understood that described aspects are not necessarily restricted to surface atom traps. In further examples, atom trap devices may also be based on three-dimensional atom trap geometries (e.g., where two or more trapping planes are arranged on top of each other).

The structured electrode layer (or the electrodes formed therein) may be configured to trap and/or shuttle atoms in a zone above the structured electrode layer (or below it, if the atom trap device 100 is mounted upside down). That is, the z-coordinate of a trapped and/or shuttled atom may differ from the z-coordinate of the x-y-plane including the structured electrode layer. In a non-limiting and purely illustrative example, a trapped atom may be trapped at a height of about 170 μm above the structured electrode layer. Trapped atoms may be shuttled (or transported) along shuttling paths of the device, which may extend above the structured electrode layer. In particular, a shuttling path may be arranged in a plane over (and in particular parallel to) the structured electrode layer. In the illustrated example, atoms may be shuttled along the x-direction. In particular, the atoms may be trapped and shuttled above the center DC electrode 4.

Time-dependent electric fields may be used for shuttling atoms along the shuttling paths. A shuttling of atoms may be controlled by electric voltages applied to the electrodes of the structured electrode layer. Atom trap devices as described herein may be configured to trap a plurality of atoms that may be individually addressable and movable by appropriately controlling the electric potentials of the electrodes. In the illustrated example, trapped atoms can be moved along shuttling paths by means of AC and DC voltages that may be separately coupled to the electrodes of the structured electrode layer. For example, the structured electrode layer may include the RF electrodes 2A, 2B for RF trapping and the DC electrodes 4, 6A, 6B for static electric-field trapping and/or for moving the atoms within the atom trap device 100.

The atom trap device 100 may further include at least one unit (not illustrated) configured to control the time-dependent electric voltages applied to the electrodes, such as one or more control chips. In this context, the atom trap device 100 may include one or more DC controllers configured to provide a plurality of DC voltages to the plurality of DC electrodes. In the illustrated example, such DC controller(s) may be electrically coupled to the plurality of DC electrodes 6A, 6B via an electrical redistribution structure 8A, 8B, which may exemplarily include a plurality of conductor lines. In particular, the RF electrodes 2A, 2B, the DC electrodes 4, 6A, 6B and the electrical redistribution structure 8A, 8B may be arranged in a common plane, i.e. in a single layer. In this case, the atom trap device 100 may also be referred to as single-layer atom trap.

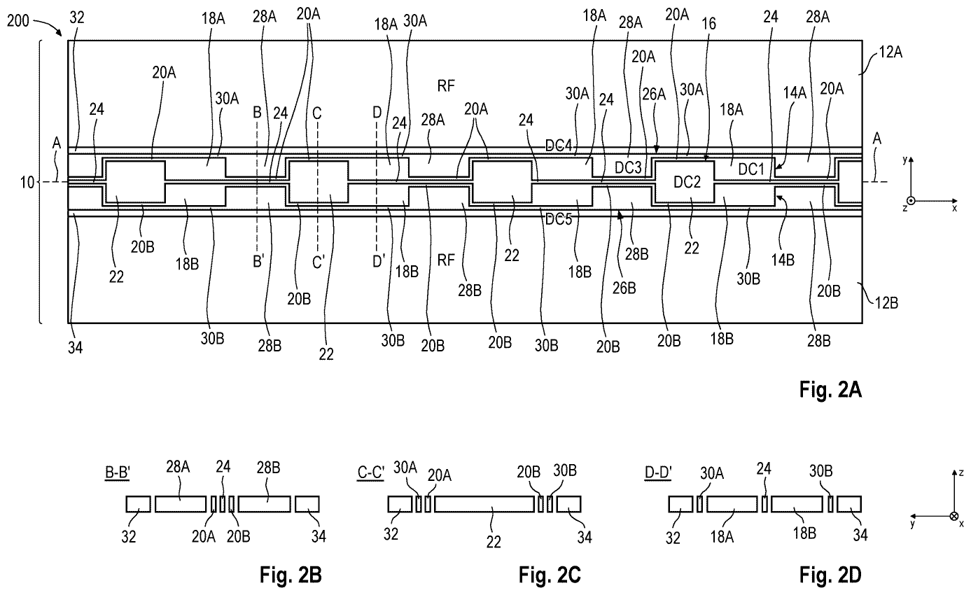

Referring now to FIGS. 2A to 2D, various views of an atom trap device 200 in accordance with the disclosure are shown. More particularly, FIGS. 2A to 2D illustrate various views of a structured electrode layer of the atom trap device 200 including electrodes formed therein. FIG. 2A illustrates a top view of the structured electrode layer, while FIGS. 2B to 2D illustrate cross-sectional side views of the structured electrode layer along sectional planes B-B′, C-C′, D-D′, respectively. It is noted that FIGS. 2A to 2D may only show a portion or a detail of the atom trap device 200, while further device components may be omitted for the sake of simplicity. The atom trap device 200 of FIGS. 2A to 2D may include one or more aspects of other atom trap devices describe herein.

The atom trap device 200 may include a structured electrode layer 10, wherein the structured electrode layer 10 may include a plurality of electrodes of an atom trap configured to trap atoms in a zone above the structured electrode layer 10. The structured electrode layer 10 and the electrodes formed therein may include or may be made of a metal, coated metal or a metal alloy, such as e.g. at least one of aluminum, copper, gold or alloys thereof. In the illustrated example, the electrodes may consist of a single metal layer. In further examples, at least one of the electrodes may be formed by a stack of conductive layers, such as e.g. Al/Ti/Pt/Au. For example, the structured electrode layer 10 may be arranged on the top surface of an (in particular dielectric) substrate (not illustrated), which may include or may be made of at least one of silicon, silicon carbide, fused silica, sapphire, glass, aluminum nitride, diamond, or the like.

The plurality of electrodes may include a first RF electrode 12A and a second RF electrode 12B extending in the x-direction, wherein the first RF electrode 12A and the second RF electrode 12B may be arranged on different sides of an axis A extending in the x-direction. The axis A is indicated by two short, dashed lines on the left and on the right of the structured electrode layer 10, but is not shown in full so as not to obscure the detailed design of the structured electrode layer 10. In the illustrated example, each of the RF electrodes 12A, 12B may have a rectangular shape. However, in further examples, the shape of the RF electrodes 12A, 12B may differ. In one example, the boundaries of the RF electrodes 12A, 12B do not need to be perfectly straight as shown in FIGS. 2A to 2D, but may be at least partially curved, meandering, or the like. In another example, the width of the RF electrodes 12A, 12B when measured in the y-direction does not need to be constant as shown in FIGS. 2A to 2D, but may increase and/or decrease along the x-direction. Furthermore, in the illustrated example, the RF electrodes 12A, 12B may have a same size. However, in further examples, the size of the first RF electrode 12A may differ from the size of the second RF electrode 12B. For example, the widths of the RF electrodes 12A, 12B when measured in the y-direction may differ from each other. In the shown case, the RF electrodes 12A, 12B may be arranged symmetrically to each other with respect to the axis A, i.e. the axis A may also be referred to as a symmetry axis. However, in further examples, the RF electrodes 12A, 12B do not need to be symmetric with respect to the axis A.

The structured electrode layer 10 may further include a plurality of DC electrodes arranged between the first RF electrode 12A and the second RF electrode 12B. In the illustrated example, each electrode arranged between the first RF electrode 12A and the second RF electrode 12B may be a DC electrode. That is, no further RF electrode(s) need to be arranged between the RF electrodes 12A, 12B. Furthermore, in the shown example, the plurality of DC electrodes may substantially fill out the whole area between the RF electrodes 12A, 12B. It is to be noted that the individual electrodes of the structured electrode layer 10 may be electrically isolated from each to other. While such electrical isolation may not necessarily become apparent from the top view of FIG. 2A, an electrical isolation between the individual electrodes can be seen from the cross-sectional side views of FIGS. 2B to 2D.

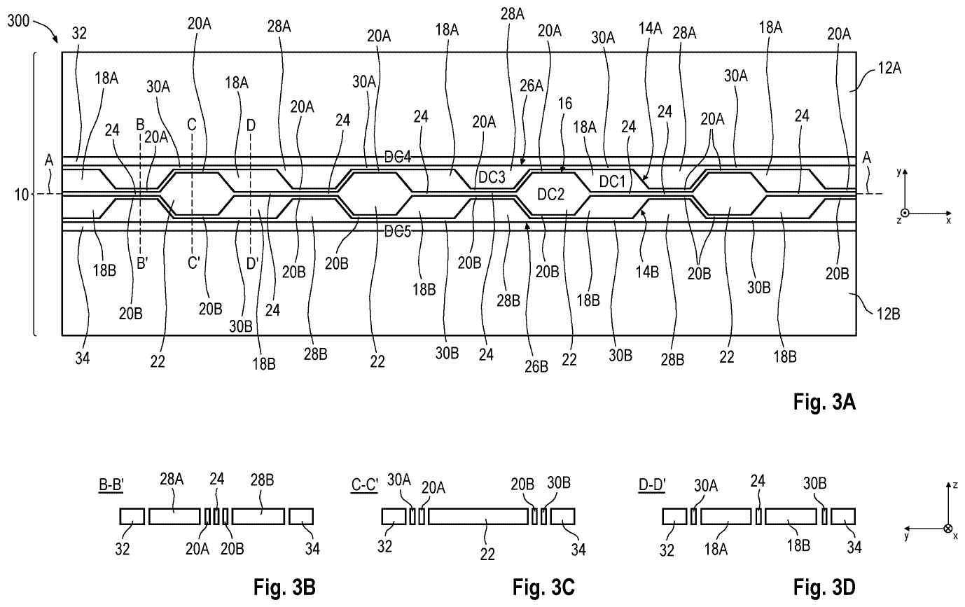

The plurality of DC electrodes may include a first DC electrode 14 (see also DC1) including a first portion 14A and a second portion 14B. In the illustrated example, each of the first portion 14A and the second portion 14B may extend from the very left to the very right of the illustrated detail of the structured electrode layer 10. The first portion 14A and the second portion 14B may be arranged symmetrically to each other with respect to the axis A, wherein the axis A may extend between the portions 14A, 14B. The first portion 14A may include a plurality of first segments 18A arranged along the x-direction. In a similar fashion, the second portion 14B may include a plurality of second segments 18B arranged along the x-direction. In the illustrated example, the first segments 18A and the second segments 18B may be arranged symmetrically to each other with respect to the axis A. In particular, the axis A may extend between the first segments 18A and the second segments 18B. In the shown case, the first segments 18A and the second segments 18B may have the shape of a rectangle. However, in further examples, the shape of the segments 18A, 18B may differ and may e.g. have the shape of a trapezoid or a parallelogram, as can e.g. be seen from the example of FIGS. 3A to 3D described later on.

The first portion 14A of the first DC electrode may further include first connection lines 20A electrically connecting the first segments 18A of the first portion 14A. In a similar fashion, the second portion 14B of the first DC electrode 14 may include second connection lines 20B electrically connecting the second segments 18B. The first connection lines 20A and the second connection lines 20B may be arranged symmetrically to each other with respect to the axis A. Since the multiple first segments 18A may be connected via the first connection lines 20A, the first portion 14A of the first DC electrode may be formed as an integral element. In a similar fashion, the second segments 18B and the second connection lines 20B connecting them may form an integral second portion 14B.

In the illustrated detail of the atom trap device 200, the first portion 14A and the second portion 14B of the first DC electrode 14 may be separate from each other. In particular, the portions 14A, 14B may be separate from each other at the positions where the atom trap device 200 is configured to trap and/or shuttle atoms. However, it is to be noted that the first portion 14A and the second portion 14B may be connected at one or more locations at e.g. the periphery of the atom trap device 200. Furthermore, the first portion 14A and the second portion 14B may be connected to a same voltage source (not illustrated). That is, a same DC voltage may be applied to the first portion 14A and the second portion 14B (see DC1).

The structured electrode layer 10 may further include a second DC electrode 16 (see also DC2) arranged symmetrically to the axis A, wherein the axis A may extend through the second DC electrode 16. The second DC electrode 16 may include a plurality of segments 22 arranged along the x-direction, wherein the axis A may extend through the segments 22. In the illustrated example, the segments 22 may be arranged symmetrically to the axis A. In particular, the segments 22 of the second DC electrode 16 may be at least partially (and in particular fully) surrounded by the first portion 14A of the first DC electrode 14 and the second portion 14B of the first DC electrode 14. In the illustrated example, the segments 22 of the second DC electrode 16 may have the shape of a rectangle. However, in further examples, the shape of the segments 22 may differ as e.g. shown in the example of FIGS. 3A to 3D described later on, where the segments 22 may have the shape of a hexagon.

The second DC electrode 16 may further include connection lines 24 electrically connecting the segments 22 of the second DC electrode 16. In the illustrated example, the connection lines 24 of the second DC electrode 16 may extend along the axis A and may at least partially coincide with the axis A. As can be seen from the cross sectional side view of FIG. 2D, the connection lines 24 of the second DC electrode 16 may be arranged between the first portion 14A of the first DC electrode 14 and the second portion 14B of the first DC electrode 14 (or more particularly, between the first segments 18A and the second segments 18B). Since the multiple segments 22 may be connected via the connection lines 24, the second DC electrode 16 may be formed as an integral element. The second DC electrode 16 may be connected to a voltage source (not illustrated) providing a DC voltage (see DC2).

The plurality of DC electrodes arranged between the RF electrodes 12A, 12B may further include a third DC electrode 26 including a first portion 26A and a second portion 26B. In the illustrated example, the first portion 26A and the second portion 26B may be arranged symmetrically to each other with respect to the axis A, wherein the axis A may extend between the first portion 26A and the second portion 26B. The first portion 26A of the third DC electrode 26 may include a plurality of first segments 28A arranged along the x-direction. In a similar fashion, the second portion 26B of the third DC electrode 26 may include a plurality of second segments 28B arranged along the x-direction. In the illustrated example, the first segments 28A and the second segments 28B of the third DC electrode 26 may be arranged symmetrically to each other with respect to the axis A. In particular, the axis A may extend between the first segments 28A and the second segments 28B of the third DC electrode 26.

The first portion 26A of the third DC electrode 26 may further include first connection lines 30A electrically connecting the first segments 28A. In a similar fashion, the second portion 26B of the third DC electrode 26 may include second connection lines 30B electrically connecting the second segments 28B. The first connection lines 30A and the second connection lines 30B may be arranged symmetrically to each other with respect to the axis A. In the illustrated example, the connection lines 30A, 30B may include sections arranged offset to the axis A. Since the multiple first segments 28A may be connected via the first connection lines 30A, the first portion 26A may be formed as an integral element. In a similar fashion, the second segments 28B and the first connection lines 30B connecting them may form an integral second portion 26B of the third DC electrode 26. The first portion 26A and the second portion 26B may be connected to a same voltage source (not illustrated). A same voltage may be applied to the portions 26A, 26B (see DC3).

The plurality of DC electrodes arranged between the RF electrodes 12A, 12B may further include a fourth DC electrode 32 (see DC4) and a fifth DC electrode 34 (see DC5) extending in the x-direction. In particular, the two DC electrodes 32, 34 may be configured for a stray field compensation in the y-direction and/or tilting the trap potential (y-z) for supporting an efficient laser cooling at any point on the axial direction. The fourth DC electrode 32 and the fifth DC electrode 34 may be arranged on different sides of the axis A. In the shown case, each of the DC electrodes 32, 34 may correspond to a DC rail having a linear shape. In one example, the DC electrodes 32, 34 may be of a rectangular shape as shown. In further examples, the shape of the DC electrodes 32, 34 may be chosen differently. In one example, the boundaries of the RF electrodes 32, 34 do not necessarily need to be perfectly straight as shown in FIGS. 2A to 2D, but may be at least partially curved, meandering, or the like. In another example, a width of the DC electrodes 32, 34 when measured in the y-direction does not need to be necessarily constant as shown in FIGS. 2A to 2D, but may increase and/or decrease along the x-direction. Furthermore, in the illustrated example, the DC electrodes 32, 34 may be of a same size. However, in further examples, the size of the fourth RF electrode 32 may differ from the size of the fifth RF electrode 34. For example, the widths of the DC electrodes 32, 34 when measured in the y-direction may differ from each other. In the illustrated example, the DC electrodes 32, 34 may be arranged symmetrically to each other with respect to the axis A extending in the x-direction. However, in further examples, the DC electrodes 32, 34 do not need to be symmetric with respect to the axis A.

The RF electrodes 12A, 12B and the plurality of DC electrodes arranged in between may be arranged in a common plane similar to the example of FIG. 1. In the shown case, the RF and DC electrodes may be arranged in a same single x-y-plane having a same z-coordinate. The atom trap device 200 may thus correspond to or may include a surface atom trap (or surface-electrode atom trap). Similar to the example of FIG. 1, the atom trap device 200 may be configured to trap and/or shuttle atoms along shuttling paths extending above the structured electrode layer 10. In the illustrated example, one or more atoms may be trapped and/or shuttled along the x-direction, wherein the atoms may be substantially arranged above the axis A. In particular, the atom trap device 200 may be configured to trap a linear atom chain arranged above the structured electrode layer 10 along the x-direction.

The atom trap device 200 may include one or more DC voltage sources (not illustrated) configured to provide DC voltages to the plurality of DC electrodes. In the illustrated example, the provided DC voltages are labeled as DC1 to DC5. In particular, the first portion 18A and the second portion 18B of the first DC electrode 18 may be provided with a same DC voltage DC1. For this purpose, the first portion 18A and the second portion 18B may be connected to a same DC voltage source. In a similar fashion, the first portion 26A and the second portion 26B of the third DC electrode 26 may be provided with a same DC voltage DC3, which may be provided by a same DC voltage source. It is to be noted that different electrodes of the structured electrode layer 10 may be electrically isolated from each other as can be seen from the sectional side views of FIGS. 2B to 2D.

The atom trap device 200 may include one or more DC controllers (not illustrated) configured to provide the plurality of DC voltages DC1 to DC5 to the multiple DC electrodes. The DC controller(s) may be electrically coupled to the plurality of DC electrodes via an electrical redistribution structure, which is not shown in the example of FIGS. 2A to 2D for the sake of simplicity. For example, the electrical redistribution structure may be arranged at a periphery of the structured electrode layer 10. In particular, the RF electrodes 12A, 12B, the plurality of DC electrodes arranged in between and the electrical redistribution structure may be arranged in a common plane (i.e. in a single layer) similar to the example of FIG. 1. It is to be noted that the atom trap device 200 may additionally include one or more RF controllers (not illustrated) configured to provide a plurality of RF voltages to the RF electrodes 12A, 12B.

Referring now to FIGS. 3A to 3D, various views of an atom trap device 300 in accordance with the disclosure are shown. More particularly, FIGS. 3A to 3D illustrate various views of a structured electrode layer of the atom trap device 300. FIG. 3A illustrates a top view of the structured electrode layer, while FIGS. 3B to 3D illustrate cross-section side views of the structured electrode layer along sectional planes B-B′, C-C′, D-D′, respectively. The atom trap device 300 of FIGS. 3A to 3D may include one or more aspects of other atom trap devices described herein.

Similar to the example of FIGS. 2A to 2D, the atom trap device 300 (or more particularly, its structured electrode layer 10) may include two RF electrodes 12A, 12B and a plurality of DC electrodes 14, 16, 26, 32 and 34 arranged in between. The reference numerals used in FIGS. 3A to 3D may refer to similar or identical elements of the atom trap device 200 of FIGS. 2A to 2D. In the illustrated example, the first segments 18A and the second segments 18B of the first DC electrode 14 may have the shape of a parallelogram (instead of the shape of a rectangle as in FIGS. 2A to 2D). In addition, the segments 22 of the second DC electrode 16 may have the shape of a hexagon (instead of the shape of a rectangle as in FIGS. 2A to 2D). Furthermore, the first segments 28A and the second segments 28B of the third DC electrode 26 may have the shape of a trapezoid (instead of the shape of a rectangle as in FIGS. 2A to 2D).

Atom trap devices in accordance with the disclosure may outperform conventional atom trap devices with regard to the following exemplary aspects.

Simulations of long range shuttling (e.g. in a range from about 100 μm to about 10 mm) for certain single-layer atom traps show that not all eigenvectors of the secular modes (associated with the Hessian of the effective potential) may remain constant in direction during the shuttling process. That is, different frequency components may couple to each other so that coherence may be lost and an additional heating may be induced during shuttling. In particular, a coupling (or heat transfer) may occur between radial and axial modes. In contrast to this, simulations of long range shuttling for atom trap devices including a structured electrode layer design as described herein showed that the eigenvectors of the secular motions may remain substantially constant during shuttling such that all frequency components may remain substantially decoupled (see e.g. FIG. 5 described later on). This way, an undesired additional heating and decoherence from mixing of modes may be avoided. Atom trap devices in accordance with the disclosure may thus provide reliable solutions for a long range shuttling of atoms.

The atom trap devices described herein may correspond to single-layer atom traps, which may be fabricated quicker and easier compared to multi-layer atom trap devices in which an electrical redistribution is not arranged in the same plane or same layer as the trap electrodes, but in one or more layers arranged below the trap electrodes. The fabrication of multi-layer atom trap devices including multiple conductive layers may require much better control of applied processes and, accordingly, can be reliably conducted only by large-scale production facilities. In multi-layer atom traps, free space may be maintained below the DC electrodes, wherein the saved space may be used for further routing of electrical signals and/or light via waveguides. The atom trap devices described herein may be laser-machined metal-coated atom traps, which are restricted to single-layer designs. In a similar fashion, the atom trap devices described herein may be YBCO (Yttrium Barium Copper Oxide) atom traps, which are limited to be single-layer atom traps. Due to its superconductive characteristics, YBCO is a promising material for atom traps. YBCO can only be grown on specific substrates.

Referring now to FIGS. 4 and 5, diagrams illustrating exemplary simulation results for shuttling an atom trapped in an atom trap device in accordance with the disclosure, such as e.g. one of the atom trap devices of FIGS. 2A-2D and 3A-3D, are shown and described. For example, the simulation results show that only low voltages may be required for an axial confinement of atoms and their shuttling. In the illustrated example, the atom may move in the x-direction at a constant y-coordinate and a constant z-coordinate. The constant y-coordinate of the atom may have an exemplary and non-limiting value of about zero when moving along the x-axis. The constant z-coordinate of the atom may have an exemplary and non-limiting value of about 170 μm, i.e. the atom may move at a height of about 170 μm above the structured electrode layer of the atom trap device.

FIG. 4 shows a diagram illustrating shuttling voltages (in units of V) that may be applied to the DC electrodes of the atom trap device for shuttling the atom in the axial direction. For example, the shuttling voltages may be provided to the DC electrodes by one or more DC controllers as described above. In particular, the shuttling voltages are plotted against the axial position of the atom (in units of 100 μm). Referring back to the examples of FIGS. 2A-2D and 3A-3D, a dashed line indicates a first shuttling voltage DC1 that may be applied to the first DC electrode 14, a dotted line indicates a second shuttling voltage DC2 that may be applied to the second DC electrode 16, and a solid line indicates a third shuttling voltage DC3 that may be applied to the third DC electrode 26. In addition, a dot-dashed line indicates a fourth shuttling voltage DC4 and a fifth shuttling voltage DC5 that may be applied to the fourth DC electrode 32 and the fifth DC electrode 34, respectively. In the illustrated example, the fourth shuttling voltage DC4 and the fifth shuttling voltage DC5 may be the same. As can be seen from FIG. 4, all shuttling voltages may have values of smaller than about 6V.

FIG. 4 shows the voltages required for confining the atom (or the ion) at axial positions (i.e. x-positions) between about −200 μm and about 200 μm. For example, at the position x=0 μm the following voltages are needed: DC1=3V, DC2=−1.1V, DC3=1.5V, DC4=DC5=0.3V. Or at the position x=100 μm the following voltages are needed: DC1=0V, DC2 =−1V, DC3=6V, DC4=DC5=0.5V. The voltages shown in the example of FIG. 4 may be configured to confine the atom at different axial positions (i.e. x-positions) at a secular frequency of about 1 MHz within a harmonic potential. It is to be noted that for different axial frequencies, the voltages would look different, but the overall trend would not change. Furthermore, the shuttling sequence is generally not fixed by fixing the frequencies. Depending on the number of degrees of freedom, many solutions may exist.

The atom may be shuttled using the illustrated shuttling voltages as follows. For example, the atom may be confined at x=0 μm and shall be shuttled to x=200 μm. At x=0 μm, we have the following voltages: DC1=3V, DC2=−1.1V, DC3=1.5V. Referring back to the example of FIG. 2A, the atom would be above DC2, because DC1 and DC3 are positive and DC2 is negative and therefore the minimum of the harmonic potential along the x-direction would be above DC2. When the atom is to be shuttled to x=200 μm, the voltages need to be changed as shown in FIG. 4 going to the right. If a linear x(t) profile is supposed, the x axis may be interchanged with a time axis. Finally, when the voltages DC1=−1V, DC2=2.2V, DC3=2.2V are achieved, the position at x=200 μm is reached, where now DC1 is negative and DC2 and DC3 are positive, which means that the atom is above DC1, because here is the new minimum of the axial confinement.

The example of FIG. 4 shows the shuttling voltages as a function of the x-position, i.e. in form of a function V(x). In some examples, shuttling parameters like velocities and accelerations may be determined by a time-dependent function x(t), such that the shuttling voltages may then be evaluated as V(x(t)).

FIG. 5 shows a diagram illustrating secular frequencies (in units of 10⁶ Hz) of the x-, y- and z-direction when shuttling the atom in the axial direction. More particularly, it is shown how the secular frequencies behave for different axial positions using the shuttling voltages of FIG. 4. The eigenvectors, determining both the directions of the secular motions and the corresponding secular frequencies, may remain substantially constant during shuttling. All frequency components may thus remain substantially decoupled such that an undesired heating and decoherence from mixing of modes may be avoided.

The examples described herein provide devices for controlling trapped atoms.

Example 1 is a device for controlling trapped atoms, the device comprising: a structured electrode layer, wherein the structured electrode layer comprises a plurality of electrodes of an atom trap configured to trap atoms in a zone above the structured electrode layer, wherein the plurality of electrodes comprises: a first RF electrode and a second RF electrode extending in a first direction, wherein the first RF electrode and the second RF electrode are arranged on different sides of an axis extending in the first direction, and a plurality of DC electrodes arranged between the first RF electrode and the second RF electrode, wherein the plurality of DC electrodes comprises: a first DC electrode comprising a first portion and a second portion, wherein the first portion and the second portion are arranged symmetrically to each other with respect to the axis, wherein the axis extends between the first portion and the second portion, and a second DC electrode arranged symmetrically to the axis, wherein the axis extends through the second DC electrode.

Example 2 is a device of Example 1, wherein the second portion of the first DC electrode is separate from the first portion of the first DC electrode.

Example 3 is a device of Example 1 or 2, wherein the first portion of the first DC electrode and the second portion of the first DC electrode are connected to a same voltage source.

Example 4 is a device of any of the preceding Examples, wherein: the first portion of the first DC electrode comprises a plurality of first segments arranged along the first direction, the second portion of the first DC electrode comprises a plurality of second segments arranged along the first direction, the first segments and the second segments are arranged symmetrically to each other with respect to the axis, and the axis extends between the first segments and the second segments.

Example 5 is a device of Example 4, wherein the first segments and the second segments of the first DC electrode have the shape of a rectangle, a trapezoid or a parallelogram.

Example 6 is a device of Example 4 or 5, wherein: the first portion of the first DC electrode comprises first connection lines electrically connecting the first segments, the second portion of the first DC electrode comprises second connection lines electrically connecting the second segments, and the first connection lines and the second connection lines are arranged symmetrically to each other with respect to the axis.

Example 7 is a device of any of the preceding Examples, wherein: the second DC electrode comprises a plurality of segments arranged along the first direction, and the axis extends through the segments of the second DC electrode.

Example 8 is a device of Example 7, wherein the segments of the second DC electrode have the shape of a rectangle or a hexagon.

Example 9 is a device of Example 4 and Example 7, wherein: the second DC electrode comprises connection lines electrically connecting the segments of the second DC electrode, the connection lines of the second DC electrode extend along the axis, and the connection lines of the second DC electrode are arranged between the first portion of the first DC electrode and the second portion of the first DC electrode.

Example 10 is a device of any of Examples 7 to 9, wherein the segments of the second DC electrode are surrounded by the first portion of the first DC electrode and the second portion of the first DC electrode.

Example 11 is a device of any of the preceding Examples, wherein the plurality of DC electrodes further comprises: a third DC electrode comprising a first portion and a second portion, wherein the first portion and the second portion are arranged symmetrically to each other with respect to the axis, wherein the axis extends between the first portion and the second portion.

Example 12 is a device of Example 11, wherein: the first portion of the third DC electrode comprises a plurality of first segments arranged along the first direction, the second portion of the third DC electrode comprises a plurality of second segments arranged along the first direction, the first segments and the second segments of the third DC electrode are arranged symmetrically to each other with respect to the axis, and the axis extends between the first segments and the second segments of the third DC electrode.

Example 13 is a device of any of the preceding Examples, wherein the plurality of DC electrodes further comprises: a fourth DC electrode extending in the first direction.

Example 14 is a device of Example 13, wherein the plurality of DC electrodes further comprises: a fifth DC electrode extending in the first direction, wherein the fourth DC electrode and the fifth DC electrode are arranged on different sides of the axis.

Example 15 is a device of Example 14, wherein the fourth DC electrode and the fifth

DC electrode have a linear shape.

Example 16 is a device of any of the preceding Examples, wherein a shuttling path of the atom trap extends above the structured electrode layer along the first direction.

Example 17 is a device of any of the preceding Examples, wherein the first RF electrode, the second RF electrode and the plurality of DC electrodes are arranged in a common plane.

Example 18 is a device of any of the preceding Examples, further comprising: a DC controller configured to provide a plurality of DC voltages to the plurality of DC electrodes, wherein the DC controller is electrically coupled to the plurality of DC electrodes via an electrical redistribution structure.

Example 19 is a device of Example 18, wherein the first RF electrode, the second RF electrode, the plurality of DC electrodes and the electrical redistribution structure are arranged in a common plane.

Example 20 is a device of any of the preceding Examples, wherein each electrode arranged between the first RF electrode and the second RF electrode is a DC electrode.

Example 21 is a device of any of the preceding Examples, wherein the atom trap is configured to trap a linear atom chain above the structured electrode layer along the first direction.

The words “over”, “above”, “beneath”, or the like, with regard to a part, element or material layer formed or located or arranged “over”, “above” or “beneath” a surface may be used herein to mean that the part, element or material layer be located (e.g. placed, formed, arranged, deposited, etc.) “directly over”, “directly above” or “directly beneath”, e.g. in direct contact with, the implied surface. The words “over”, “above”, “beneath”, or the like, used with regard to a part, element or material layer formed or located or arranged “over”, “above” or “beneath” a surface may, however, either be used herein to mean that the part, element or material layer be located (e.g. placed, formed, arranged, deposited, etc.) “indirectly over”, “indirectly above” or “indirectly beneath” the implied surface, with one or more additional parts, elements or layers being arranged between the implied surface and the part, element or material layer.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A device for controlling trapped atoms, the device comprising:
a structured electrode layer comprising a plurality of electrodes of an atom trap configured to trap atoms in a zone above the structured electrode layer, wherein the plurality of electrodes comprises:
a first RF electrode and a second RF electrode extending in a first direction, wherein the first RF electrode and the second RF electrode are arranged on different sides of an axis extending in the first direction; and
a plurality of DC electrodes arranged between the first RF electrode and the second RF electrode, wherein the plurality of DC electrodes comprises:
a first DC electrode comprising a first portion and a second portion, wherein the first portion and the second portion are arranged symmetrically to each other with respect to the axis, wherein the axis extends between the first portion and the second portion; and
a second DC electrode arranged symmetrically to the axis, wherein the axis extends through the second DC electrode.

2. The device of claim 1, wherein the second portion of the first DC electrode is separate from the first portion of the first DC electrode.

3. The device of claim 1, wherein the first portion of the first DC electrode and the second portion of the first DC electrode are connected to a same voltage source.

4. The device of claim 1, wherein:
the first portion of the first DC electrode comprises a plurality of first segments arranged along the first direction;
the second portion of the first DC electrode comprises a plurality of second segments arranged along the first direction;
the first segments and the second segments are arranged symmetrically to each other with respect to the axis; and
the axis extends between the first segments and the second segments.

5. The device of claim 4, wherein the first segments and the second segments of the first DC electrode have a shape of a rectangle, a trapezoid or a parallelogram.

6. The device of claim 4, wherein:
the first portion of the first DC electrode further comprises a plurality of first connection lines electrically connecting the first segments;
the second portion of the first DC electrode further comprises a plurality of second connection lines electrically connecting the second segments; and
the first connection lines and the second connection lines are arranged symmetrically to each other with respect to the axis.

7. The device of claim 1, wherein:
the second DC electrode comprises a plurality of segments arranged along the first direction; and
the axis extends through the segments of the second DC electrode.

8. The device of claim 7, wherein the segments of the second DC electrode have a shape of a rectangle or a hexagon.

9. The device of claim 7, wherein:
the first portion of the first DC electrode comprises a plurality of first segments arranged along the first direction;
the second portion of the first DC electrode comprises a plurality of second segments arranged along the first direction;
the first segments and the second segments of the first DC electrode are arranged symmetrically to each other with respect to the axis;
the axis extends between the first segments and the second segments of the first DC electrode;
the second DC electrode further comprises a plurality of connection lines electrically connecting the segments of the second DC electrode;
the connection lines of the second DC electrode extend along the axis; and
the connection lines of the second DC electrode are arranged between the first portion of the first DC electrode and the second portion of the first DC electrode.

10. The device of claim 7, wherein the segments of the second DC electrode are surrounded by the first portion of the first DC electrode and the second portion of the first DC electrode.

11. The device of claim 1, wherein the plurality of DC electrodes further comprises:
a third DC electrode comprising a first portion and a second portion, wherein the first portion and the second portion of the third DC electrode are arranged symmetrically to each other with respect to the axis, wherein the axis extends between the first portion and the second portion of the third DC electrode.

12. The device of claim 11, wherein:
the first portion of the third DC electrode comprises a plurality of first segments arranged along the first direction;
the second portion of the third DC electrode comprises a plurality of second segments arranged along the first direction;
the first segments and the second segments of the third DC electrode are arranged symmetrically to each other with respect to the axis; and
the axis extends between the first segments and the second segments of the third DC electrode.

13. The device of claim 1, wherein the plurality of DC electrodes further comprises:
a fourth DC electrode extending in the first direction.

14. The device of claim 13, wherein the plurality of DC electrodes further comprises:
a fifth DC electrode extending in the first direction,
wherein the fourth DC electrode and the fifth DC electrode are arranged on different sides of the axis.

15. The device of claim 14, wherein the fourth DC electrode and the fifth DC electrode have a linear shape.

16. The device of claim 1, wherein a shuttling path of the atom trap extends above the structured electrode layer along the first direction.

17. The device of claim 1, wherein the first RF electrode, the second RF electrode and the plurality of DC electrodes are arranged in a common plane.

18. The device of claim 1, further comprising:
a DC controller configured to provide a plurality of DC voltages to the plurality of DC electrodes, wherein the DC controller is electrically coupled to the plurality of DC electrodes via an electrical redistribution structure.

19. The device of claim 18, wherein the first RF electrode, the second RF electrode, the plurality of DC electrodes, and the electrical redistribution structure are arranged in a common plane.

20. The device of claim 1, wherein each electrode arranged between the first RF electrode and the second RF electrode is a DC electrode.

21. The device of claim 1, wherein the atom trap is configured to trap a linear atom chain above the structured electrode layer along the first direction.
